(19) United States
(12) Patent Application Publication
(10) Pub. No.: US 2014/0304252 A1
(43) Pub. Date: Oct. 9, 2014

(54) METHOD, APPARATUS AND MACHINE READABLE MEDIA FOR PRESENTING MOBILE MEDIA INFORMATION IN MOBILE SEARCH SYSTEM

(71) Applicant: TENCENT TECHNOLOGY (SHENZHEN) COMPANY LIMITED, Shenzhen City (CN)

(72) Inventors: Liang SUN, Shenzhen City (CN); Huifang DENG, Shenzhen City (CN)

(21) Appl. No.: 14/310,291

(22) Filed: Jun. 20, 2014

Related U.S. Application Data
(63) Continuation of application No. PCT/CN2012/086726, filed on Dec. 17, 2012.

(30) Foreign Application Priority Data
Dec. 28, 2011 (CN) 201110448849.1

(51) Int. Cl. G06F 17/30

(52) U.S. Cl. CPC G06F 17/30522
USPC 707/721

(57) ABSTRACT

The present disclosure provides a method, an apparatus and a machine readable medium for presenting mobile media information in a mobile search system. The method comprises: acquiring a user's usage information in the mobile search system and analyzing the acquired user's usage information to obtain the user's consumption characteristics information; finding corresponding mobile media information that matches the user's consumption characteristics information and presenting the matched mobile media information. The invention may improve targeted presentation of mobile media information to target users.

### CROSS REFERENCE TO RELATED APPLICATION

This application is a continuation of International Application No. PCT/CN2012/086726, filed on Dec. 17, 2012, which claims priority to Chinese patent application No.201110448849.1 filed in the SIPO on Dec. 28, 2011 with title of “METHOD, APPARATUS AND MACHINE READABLE MEDIA FOR PRESENTING MOBILE MEDIA INFORMATION IN MOBILE SEARCH SYSTEM”, the entire content of which are hereby incorporated by reference.

### TECHNICAL FIELD

The present disclosure relates to the technique of mobile internet data processing, and in particular to a method, an apparatus and a machine readable medium for presenting mobile media information in a mobile search system.

### BACKGROUND ART

The mobile internet combines the mobile communication and the Internet into one integer. In recent years, mobile communication and the Internet have become the world's fastest growing technical fields with the largest market potential and the most attractive prospects, and on such a basis the mobile internet technology is also updating and developing at an unprecedented speed. The mobile internet is more advantageous than the Internet, because mobility enables users to receive information anywhere, anytime. The current mobile internet has become an important tool for people to obtain information. A user may login the mobile internet via a mobile terminal such as a mobile phone to get a lot of information from the Internet.

Mobile media information refers to various kinds of information that are presented on a presentation media (e.g., a client interface on a mobile phone, a web page on a mobile phone, etc.) of a mobile internet user by using digital codes as a carrier. Mobile media information is often highly targeted, and its content often influences attitudes, intentions and behaviors of the audience, so how effectively to present to specific audience targeted mobile media information is concerned by the industry of the mobile internet technology.

Existing methods for presenting mobile media information include: a) broadcasting the information by using the Short Message Service technology of the mobile communications, in which a short message is used as a carrier; b) alternatively, further embedding the mobile media information into the content of the short message for presenting; and c) presenting the mobile media information near the content being viewed by the mobile internet user when the user is browsing internet content via a mobile terminal.

However, the above-described conventional methods for presenting mobile media information all have a broadcasting nature and can not accurately and effectively present corresponding mobile media information to target users.

### SUMMARY OF INVENTION

Therefore, the embodiments of the present disclosure provide a method, an apparatus and a machine readable medium for presenting mobile media information in the mobile search system, in order to improve accurate targeted present of the mobile media information to target users.

A method for presenting mobile media information in a mobile search system comprises: acquiring a user's usage information in the mobile search system and analyzing the acquired user's usage information to obtain the user's consumption characteristics information; finding corresponding mobile media information that matches the user's consumption characteristics information and presenting the matched mobile media information.

An apparatus for presenting mobile media information in a mobile search system comprises: a consumption characteristics analysis module, configured to acquire a user's usage information in the mobile search system and analyze the acquired user's usage information to obtain the user's consumption characteristics information; a mobile media information matching module, configured to find corresponding mobile media information that matches the user's consumption characteristics information; and a mobile search presenting module, configured to present the matched mobile media information and background retrieval result.

A machine readable medium on which sets of instructions are stored, wherein the sets of instructions, when being executed, enable the machine to perform any of the above-described methods for presenting mobile media information in a mobile search system.

The present disclosure analyzes usage information of a user in the mobile search system to obtain the user's consumption characteristics information, and finds and presents corresponding mobile media information that matches with the user's consumption characteristics information. Thus, the user's consumption characteristics information can be precisely targeted relying on the platform of the mobile search system, and the corresponding mobile media information can be pushed to the user, and accordingly the precise targeted presentation of the mobile media information to the target users can be improved.

### BRIEF DESCRIPTION OF THE DRAWINGS

FIG. 1 is a flowchart illustrating a method for presenting mobile media information in a mobile search system according to the present disclosure;

FIG. 2 illustrates specific data types that a user's consumption characteristics information can include according to the present disclosure;

FIG. 3 illustrates specific data types that a user's real-time scenario information of a retrieval result page can include according to the present disclosure;

FIG. 4 illustrates specific data types that the user's real-time scenario information of a TransCode (TC) page can include according to the present disclosure;

FIG. 5 is a flowchart illustrating a analysis method for obtaining a user's retrieval type according to the present disclosure;

FIG. 6 is a schematic diagram illustrating a construction of an apparatus according to the present disclosure;

FIG. 7 is a schematic diagram illustrating components of a consumption characteristics analysis module according to the present disclosure.

### DETAILED DESCRIPTION the drawings and detailed embodiments.

The embodiments of the present disclosure improve precise targeted presentation of mobile media information to target users based on a mobile search system. Mobile search indicates that a user searches for content, such as information, entertainment, etc. via a mobile terminal (such as a mobile phone, a computer, etc.) by using the approach of the Wireless Application Protocol (WAP), a client, etc., and the system that provides such a mobile search function is referred to as a mobile search system.

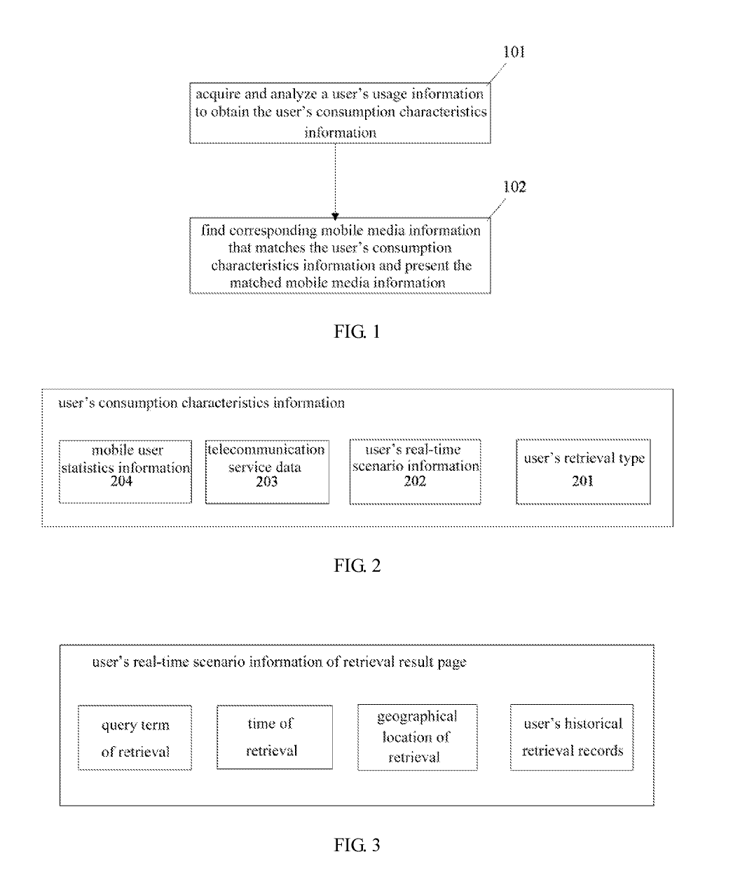

FIG. 1 is a flowchart illustrating the method for presenting the mobile media information in the mobile search system according to an embodiment of the present disclosure. Referring to FIG. 1, the method mainly includes the following steps:

At Step 101, a user's usage information in the mobile search system is acquired and analyzed to obtain the user's consumption characteristics information.

At Step 102, corresponding mobile media information that matches the user's consumption characteristics information is found, and the matched mobile media information is presented. The specific method of finding the matched mobile media information is as follows: the mobile media information is classified and a keyword is set for each piece of the mobile media information in advance. In finding the matched mobile media information, the type of the corresponding mobile media information is determined based on the consumption characteristics information, and then the specific mobile media information, the keyword of which matches the consumption characteristics information, is searched for from among the determined type of mobile media information and is used as the final matched result.

Presenting the matched mobile media information specifically refers to presenting the matched mobile media information on the user's mobile terminal. For example, the information can be presented on the user's retrieval page, wherein the user's retrieval page refers to a retrieval page of the mobile terminal (e.g., a mobile phone client) that the user uses to access the mobile search system, and includes a retrieval result page, a result content page, etc.

The user's usage information in the mobile search system in Step 101 mainly includes the user's historical retrieval records and real-time scenario information of the user's current retrieval. The real-time scenario information of the user's current retrieval refers to information about the scenario in which the user needs to use the mobile terminal (e.g., the mobile phone client) to access the mobile search system to perform retrieval. By using and analyzing the user's historical retrieval records and the real-time scenario information of the user's current retrieval, the retrieval type which represents the user's intention for the retrieval can be obtained, and the retrieval type can be used as the user's consumption characteristics information.

FIG. 2 illustrates the specific data types that the user's consumption characteristics information can include, according to the embodiment of the present disclosure. Referring to FIG. 2, in addition to the user's retrieval type 201, the consumption characteristics information can directly includes the real-time scenario information 202 of the user's current retrieval, as well as the user's telecommunication service data 203 and the user's statistics data in the mobile internet system 204 (hereinafter, referred to in short as mobile user statistics data).

The retrieval type 201 can be obtained by analyzing the user's historical retrieval records and the real-time scenario information 202. The historical retrieval records can be acquired from a recording system of the mobile search system, and can mainly include a series of information regarding the retrieval process, such as portal of the retrieval (for example, by means of directly inputting a query term, or by means of simply clicking a piece of text with a link), time of the retrieval, query terms of the retrieval, clicking actions on a result page of the retrieval, page-turning actions, the period of time taken by the retrieval process, and so on.

The user's real-time scenario information 202 can be obtained from a front-end module of the mobile search system when the user performs the retrieval. The user's real-time scenario information refers to related information about the mobile user logging in on the mobile search engine, and specifically includes: the user's real-time scenario information of a retrieval result page in the user's retrieval process, and/or the user's real-time scenario information of a TransCode (TC) page in the user's retrieval process. A TC page refers to a page that is transformed from a typical computer web page to be suitable for accessing via a mobile terminal (such as a mobile phone).

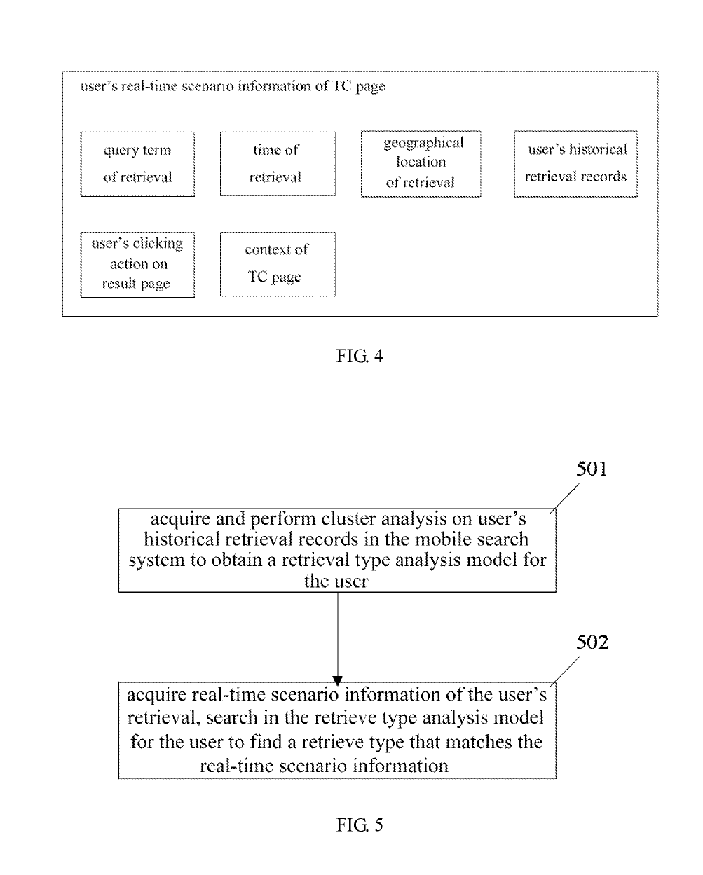

FIG. 3 illustrates the specific data types that the user's real-time scenario information of the retrieval result page can include, according to the embodiment of the present disclosure. Referring to FIG. 3, the user's real-time scenario information of the retrieval result page specifically includes information on at least one of query terms of the retrieval, time of the retrieval, geographical location of the retrieval, etc. When the user is a logged-in user, the user's real-time scenario information may further include the historical retrieval records of the user. The historical retrieval records can be acquired from the recording system of the mobile search system.

FIG. 4 illustrates the specific data types that the user's real-time scenario information of the TC page can include, according to the embodiment of the present disclosure. Referring to FIG. 4, the user's real-time scenario information of the TC page specifically includes information on at least one of query terms of the retrieval, time of the retrieval, geographical location of the retrieval, the user's clicking action on the result page, context of the TC page, etc. When the user is a logged-in user, the user's real-time scenario information may further include the historical retrieval records of the user.

The user's real-time scenario information can be added directly into the user's consumption characteristics information regardless of the user of the current retrieval is a logged-in user or a non-logged-in user. Since the user's real-time scenario information in the user's retrieval process is used as a part of the user's consumption characteristics information, the user's real-time scenario information can become an important factor in finding the matched media information that is finally presented to the user. For example, in a mobile retrieval result page, the query terms of the retrieval become an important factor for finding the matched mobile media information. If the user clicks on the retrieval result page to view content of the result page, the information on the content of the result page will be added as another important factor for finding the matched mobile media information.

The telecommunication service data as mentioned above can be acquired from systems of telecommunication service providers, and may include the terminal type of the mobile phone that the user uses, monthly bill, whether a monthly browsing package is subscribed, etc. The systems of the telecommunication service providers have records regarding the monthly bill, the terminal type, etc. of a logged-in user. The information for a non-logged-in user can be determined by using outcome of statistical analysis on large sample data, such as 20% of users are using smart phones, etc.

The user's statistics information 204 in the mobile internet system as mentioned above can be acquired from the user management system of the corresponding mobile internet, and may include, e.g., information on attributes that a mobile user has registered in the mobile internet system, including gender, age, occupation etc. of the user. The user management system has records about all information on the attributes of a logged-in user. The information for a non-logged-in user can be determined by using outcome of statistical analysis on large sample data, such as 30% of users are in age from 30 to 40, etc.

Among the user's consumption characteristics information, the acquisition of the user's retrieval type 201 requires analyzing and processing of original data. FIG. 5 illustrates the detailed analysis and process method, which comprises the following steps:

At Step 501, the user's historical retrieval records in the mobile search system are acquired and cluster analyzed to obtain a retrieval type analysis model for the user;

At Step 502, the real-time scenario information for the user's current retrieval is acquired, and the retrieval type that marches the real-time scenario information is searched for in the retrieve type analysis model for the user.

The process of obtaining the retrieval type analysis model in Step 501 is a cluster analysis process, and mainly includes: analyzing the user's retrieval process information based on entire historical retrieval data of the mobile user (the “entire” here is in a relative sense, and the “entire historical retrieval data” essentially refers to sample data that is sampled from the entire historical retrieval data), such as the query terms that the mobile user has entered, records about clicking on the result pages, actions of browsing the result pages, etc., to classify and count the user's retrieval needs and obtain the retrieval type analysis model which consists of classification and statistics information. For example, among the historical retrieval query terms, if a certain percentage of the user's retrieval needs are online games, a certain percentage are online shopping, and a certain percentage are online chat, then the related information can be recorded into the retrieval type analysis model.

The specific method for obtaining a user's retrieval type analysis model by analyzing the historical retrieval records shall distinguish between the case of a logged-in user and the case of a non-logged-in user.

With respect to a logged-in user of the mobile search system, the historical retrieval records of the user are recorded in a dedicated file. The method according to an embodiment of the present disclosure can read every logged-in user's historical retrieval record file to acquire and analyze the logged-in user's historical retrieval records, and then obtain a retrieval type analysis model for every logged-in user. The specific analysis process may include, for example, analyzing and getting statistics information such as retrieval concentration or retrieval frequency, etc. of the user's retrieval process information to obtain the retrieval information that can represent best the intention of the user's retrieval. For example, if more than a predetermined percentage of retrieval query terms in a certain period of time belong to a certain type of query terms, e.g., if in the recent week more than 80% of the retrieval query terms of the user are related to the type of Game, then the related statistics information is recorded, and if later the user performs retrieval with the same retrieval query terms again, it can be determined that the preferable retrieval type is “Game”. In another example, taking day as a unit, if the user's retrieval requests for movie information are more than a predetermined times (e.g., 3 times) everyday in the last week, then the related statistics information is recorded, and if later the user performs retrieval with the same retrieval query terms again, it can be determined that the preferable retrieval type is “Movie Information.”

With respect to a non-logged-in user, the embodiment of the present disclosure may not be able to find the historical retrieval records of the user, therefore analyze retrieval process information of all mobile users (the “all” here is in a relative sense, and the “all mobile users” essentially refers to sample users that are sampled from all mobile users) on the basis of entire historical data of the users (the “entire” here is also in a relative sense, and “the entire historical data” essentially refers to sample data that is sampled from the entire historical data), and classify retrieval needs of the users to obtain a retrieval type analysis model that may represent all of the non-logged-in users. The specific analysis process may comprise, e.g., getting statistics information about popularity of some retrieval information and finding corresponding retrieval types, or it is possible to determine different retrieval types for same retrieval information based on its final clicking results, so as to find the retrieval types representing best the users' retrieval intentions. For example, if 80% of the users who perform retrieval with the query term “apple” are intended to retrieve information on electronic products provided by Apple Inc., 15% are intended to retrieve information on the fruit, 5% are intended to retrieve information on a movie named Apple, and so on, then the related statistics information can be recorded in the retrieval type analysis model, and if subsequently the user performs retrieval with the retrieval query term “apple” again, it can be determined that the preferable retrieval type is “Electronic Product.”

The process of obtaining the user's retrieval type analysis model of Step 501 as described above is completed off-line, and the model is stored in the system. When a user accesses the mobile search system to perform retrieval, the system may determine a retrieval type that represents best the user's intention based on the user's real-time scenario information and the retrieval type analysis model. In addition, the current real-time scenario information of the user can be analyzed and counted, so as to be added to the retrieval type analysis model, to supplement and correct the previous retrieval type analysis model.

With respect to a logged-in user, a tag can be given to the logged-in user, and all the consumption characteristics information acquired from each of the subsequent retrievals of the user can be used to supplement and correct previous consumption characteristics information of the user.

The more frequently the cluster analysis for the retrieval type analysis model is performed and the more historical data the retrieval type analysis model is based on, the more detailed retrieval type analysis model can be obtained. For example, the retrieval type is not limited to the large types such as Entertainment, Food and Drink, and can be subdivided into smaller types. For example, Entertainment can be subdivided into smaller types such as Mobile Phone Game, Mobile Phone Video, Mobile Phone Music, Mobile Phone Novel, etc., and Life can be subdivided into smaller types such as Restaurant, Shopping Mall, Cinema, etc, so that the user's retrieval intention can be determined in more detail.

As described above, in Step 502, when a user performs retrieval via the mobile search system, the embodiment of the present disclosure needs to acquire the real-time scenario information of the user's retrieval and looks up in the retrieval type analysis model to find the retrieval type that matches the real-time scenario information.

The process of finding the matched retrieval type and the process of finding the matched mobile media information that is finally presented to the user are further illustrated below.

For example, in the previous example of obtaining a retrieval type analysis model for the non-logged-in users, the statistics shows that 80% of the browsing results for the retrieval query term “apple” indicate that the user is retrieving information about the electronic products from Apple Inc., thus the type corresponding to the keyword “apple” is preferably set as “Electronic Product.” When a non-logged-in user performs retrieval with the query term “apple,” the real-time scenario information of the user includes the retrieval query term “apple,” and the system will determine based on the above retrieval type analysis model that the user's retrieval type corresponding to the query term “apple” is preferably “Electronic Product.” In the subsequent steps, the system searches the Electronic Product type of mobile media information to find the mobile media information with the keyword of “apple,” and presents the found mobile media information on the user's mobile terminal.

Additionally, the real-time scenario information for a non-logged-in user may further include information such as time of the retrieval, geographical location of the retrieval, etc., and/or may include information such as the user's clicking action on the result page, the context of the TC page, etc., therefore the mobile media information that matches such real-time scenario information can also be selected in the process of finding the matched mobile media information. For example, the mobile media information that matches the geographical location of the user's retrieval (i.e., mobile media information for the region in which the user is located), or the mobile media information that matches the user's clicking action on the result page and the context of the TC page (which further reflect the content that the user is currently intended to search), can be selected and presented on the mobile terminal of the user.

As another example, in the previous example of obtaining the retrieval type analysis model for a logged-in user, if a certain logged-in user's retrieval requests for movie information is more than a predetermined times (e.g., 3 times) everyday in the last week, then the type of Movie Information is recorded as a preferable retrieval type for the user. When the logged-in user performs retrieval with “Red Cliff”, the real-time scenario information of the user then includes the retrieval query word “Red Cliff”, and the system may determine that the user's current retrieval type is “Movie Information” based on the retrieval type analysis model for the user. In the subsequent steps, the system searches mobile media information of the Movie Information type to find the mobile media information with the keyword of “Red Cliff” (i.e., information related to the movie named “Red Cliff”), and presents the found mobile media information on the user's mobile terminal.

Additionally, the real-time scenario information for the logged-in user may further include information such as time of the retrieval, geographical location of the retrieval, the user's historical retrieval records, etc., and/or may include information such as the user's clicking action on the result page, the context of the TC page, etc., therefore the mobile media information that matches such real-time scenario information can also be selected in the process of finding matched mobile media information. For example, the mobile media information that matches the geographical location of the user's retrieval (i.e., information related to the movie “Red Cliff” within the region in which the user is located), or the mobile media information that matches the user's clicking action on the result page and the context of the TC page (which further reflect the content that the user is intended to search currently), can be selected and presented on the mobile terminal of the user. For example, if the context of the user's current TC page is mainly introduction of cinemas, then cinema information with the keyword of “Red Cliff” can be presented on the mobile terminal of the user.

Additionally, the consumption characteristics information of the user may include the user's telecommunication service data and the logged-in user's statistics data in the mobile internet system. In the process of finding the matched mobile media information for the user, the mobile media information with keywords that correspond to such consumption characteristics information may be selected and presented on the mobile terminal of the user.

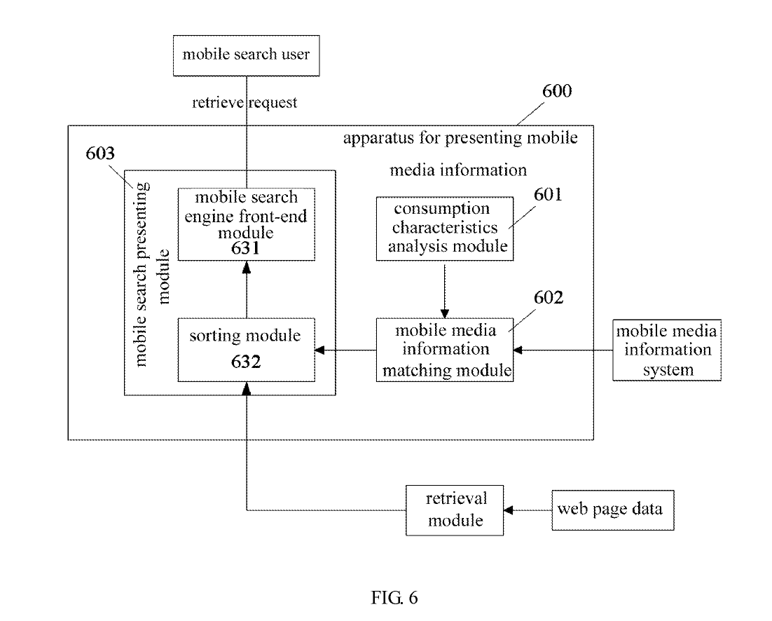

In correspondence to the method according to the embodiment of the present disclosure, an apparatus for presenting the mobile media information in the mobile search system is also disclosed. FIG. 6 is a schematic diagram illustrating a construction of the apparatus. Referring to FIG. 6, the apparatus 600 for presenting the mobile media information in the mobile search system comprises:

A consumption characteristics analysis module 601 for acquiring and analyzing a user's usage information in the mobile search system to obtain the user's consumption characteristics information.

A mobile media information matching module 602 for finding corresponding mobile media information that matches the user's consumption characteristics information from the mobile media information system.

A mobile search presenting module 603 for presenting the matched mobile media information and background retrieval result in response to the user's retrieval request. Specifically, the mobile search presenting module 603 includes a mobile search engine front-end module 632 and a sorting module 632. The mobile search engine front-end module 632 is configured to receive retrieval request from the user, and present the retrieved pages. The sorting module 632 is configured to combine and sort the retrieval result returned from the retrieving module and the matched mobile media information from the mobile media information matching module 602, and transmit the sorted retrieval result and mobile media information to the mobile search engine front-end module 603 for presenting.

The user's consumption characteristics information according to the embodiment of the present disclosure may include the user's retrieval type, and may further include the real-time scenario information of the user's current retrieval, the user's telecommunication service data and the mobile user statistics data.

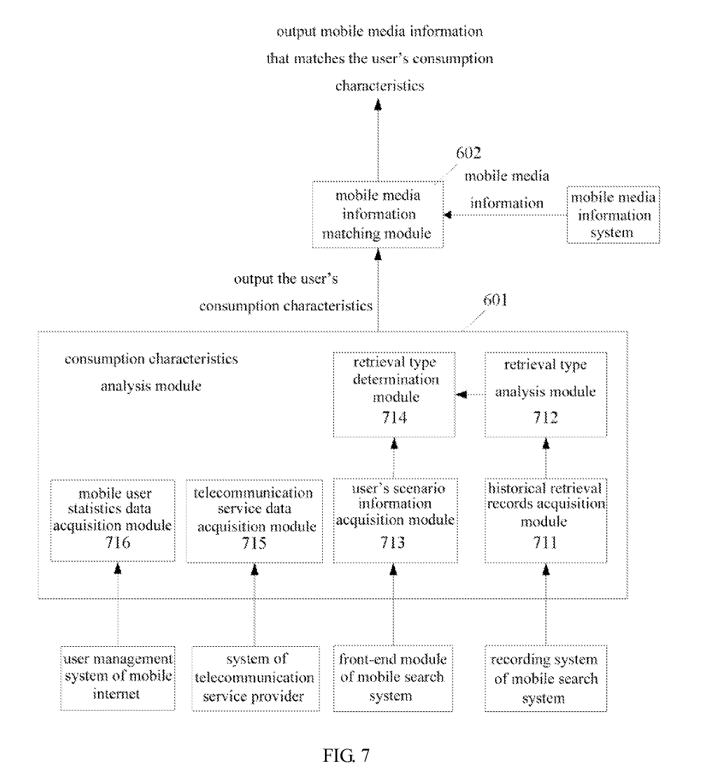

FIG. 7 is a schematic diagram illustrating components of the consumption characteristics analysis module according to the embodiment of the present disclosure. Referring to FIG. 7, the consumption characteristics analysis module 601 particularly includes:

A historical retrieval records acquisition module 711 for acquiring the user's historical retrieval records in the mobile search system from a recording system of the mobile search system.

A retrieval type analysis module 712 for cluster analyzing the user's historical retrieval records acquired by the historical retrieval records acquisition module 711 to obtain the retrieval type analysis model for the user.

A user's real-time scenario information acquisition module 713 for acquiring the real-time scenario information of the user's retrieval from the front-end module of the mobile search system.

A retrieval type determination module 714, for searching the retrieval type analysis module for the user, which is determined by the retrieval type analysis module 712, to find the retrieval type that matches the user's real-time scenario information acquired by the user's real-time scenario information acquisition module 713, and the retrieval type can be used as a part of the consumption characteristics information of the user to find the matched mobile media information.

Furthermore, in addition to being input into the retrieval type determined by the retrieval type analysis module 712, the scenario information acquired by the user's real-time scenario information acquisition module 713 can also be used as a part of the consumption characteristics information of the user for finding the matched mobile media information.

As illustrated in FIG. 7, the consumption characteristics analysis module may further include a telecommunication service data acquisition module 715 for acquiring data on telecommunication services of the user from the systems of the telecommunication service providers, and the acquired telecommunication service data can be used as a part of the consumption characteristics information of the user for finding the matched mobile media information.

The consumption characteristics analysis module may further include a mobile user statistics data acquisition module 716 for acquiring the user's statistics data in the mobile internet system from the user management system of the corresponding mobile internet.

The statistics data can be used as a part of the consumption characteristics information of the user for finding the matched mobile media information.

Obviously, the telecommunication service data acquisition module 715 and the mobile user statistics data acquisition module 716 can be optional in other embodiments.

Referring to FIGS. 6 and 7, the overall process of presenting to a user the mobile media information that corresponds to the user's consumption characteristics information the user includes: the user submits a mobile search query request logging into the mobile search engine system via his/her mobile terminal, the mobile search engine returns a retrieval page to the user's mobile terminal. Upon the mobile user submitting the retrieval request, the consumption characteristics analysis module 601 may analyzes information such as the user's telecommunication service data (e.g., monthly bill, calling time, etc.), the mobile user statistics data (e.g., gender, age, etc.), real-time scenario information (e.g., the retrieval query term, the records of clicking on the result page, the context of the result page, the time of the retrieval, the location of the retrieval, etc.), the retrieval type (e.g., Information, Entertainment, Life, etc.), and so on to obtain the consumption characteristics of the user. The mobile media information matching module 602 may find the mobile media information that matches such consumption characteristics information from the mobile media information system based on such consumption characteristics information, to obtain and present the mobile media information that is most suitable for the current needs of the user on the retrieval page of the user's terminal. Thus, the mobile search media information from the media information provides can be precisely distributed to meet the potential needs of the mobile search user.

The embodiment of the present disclosure also provides a machine readable medium, on which sets of instructions are stored, wherein the sets of instructions, when being executed, enable the machine to perform the method that is described in any of the above embodiments. The machine readable media can be a floppy disc, hard disc or optical disc, etc., of a computer, and the machine can be a mobile phone, a personal computer, a server or a network device, etc.

The above described are only the preferred embodiments of the present disclosure, which are not intended to limit the scope of the invention. Any modification, equivalence, and improvement within the spirit and scope of the disclosure are intended to be comprised within the scope of invention.

1. A method for presenting mobile media information in a mobile search system, comprising:
acquiring a user's usage information in the mobile search system;
analyzing the acquired user's usage information to obtain the user's consumption characteristics information;
finding corresponding mobile media information that matches the user's consumption characteristics information; and
presenting the matched mobile media information.

2. The method of claim 1, wherein the user's consumption characteristics information comprises the user's retrieval type, and
wherein the acquiring and analyzing of the user's usage information in the mobile search system to obtain the user's consumption characteristics information comprises:
acquiring user's historical retrieval records in the mobile search system;
performing cluster analysis on the acquired user's historical retrieval records to obtain a retrieval type analysis model for the user;
acquiring real-time scenario information of the user's retrieval;
and searching in the retrieve type analysis model for the user to find a retrieve type that matches the real-time scenario information.

3. The method of claim 2, wherein performing cluster analysis on the user's historical retrieval records in the mobile search system to obtain the retrieval type analysis model for the user comprises: analyzing the retrieval process information of user's historical retrieval data in the mobile search system to classify and count retrieval needs of the user, and obtaining the retrieval type analysis model which consists of classification and statistics information.

4. The method of claim 3, wherein performing cluster analysis to obtain the retrieval type analysis model comprises:
if the user is a logged-in user, performing cluster analysis on the historical retrieval records of the logged-in user himself/herself to obtain the retrieval type analysis model; and
if the user is a non-logged-in user, obtaining sample users by sampling out some users from all of the non-logged-in users, and performing cluster analysis on the historical retrieval records of the sample users to obtain the retrieval type analysis model.

5. The method of claim 1, wherein, the acquiring of the user's usage information in the mobile search system comprises acquiring the real-time scenario information of the user's retrieval; and
wherein the method further comprises using the real-time scenario information of the user's retrieval as a part of the user's consumption characteristics information to find the matched mobile media information.

6. The method of claim 5, wherein the real-time scenario information of the user's retrieval comprises the user's real-time scenario information of a retrieval result page in the user's retrieval process, and/or the user's real-time scenario information of a TransCode (TC) page in the user's retrieval process.

7. The method of claim 6, wherein the user's real-time scenario information of a retrieval result page comprises at least one of a query term of the retrieval, time of the retrieval and the geographical location of the retrieval;
wherein the user's real-time scenario information of the TC page comprises at least one of a query term of the retrieval, time of the retrieval, the geographical location of the retrieval, the user's clicking action on a result page, and context of the TC page; and
wherein, when the user is a logged-in user, the user's real-time scenario information further comprises the historical retrieval records of the user.

8. The method of claim 1, further comprising acquiring the user's telecommunication service data, and using the telecommunication service data as a part of the user's consumption characteristics information to find the matched mobile media information.

9. The method o f claim 1, further comprising acquiring the user's statistics information in a mobile internet system, and using the statistics information as a part of the user's consumption characteristics information to find the matched mobile media information.

10. The method of claim 1, wherein finding corresponding mobile media information that matches the user's consumption characteristics information comprises:
classifying the mobile media information and setting a keyword for each piece of the mobile media information in advance, and during finding the matched mobile media information, determining a type of the corresponding mobile media information based on the consumption characteristics information, and searching in the corresponding type of mobile media information to find the mobile media information, the keyword of which matches the consumption characteristics information, as a final matched result.

11. An apparatus for presenting mobile media information in a mobile search system, comprising:
a consumption characteristics analysis module, configured to acquire a user's usage information in the mobile search system and analyze the acquired user's usage information to obtain the user's consumption characteristics information;
a mobile media information matching module, configured to find corresponding mobile media information that matches the user's consumption characteristics information; and
a mobile search presenting module, configured to present the matched mobile media information.

12. The apparatus of claim 11, wherein the consumption characteristics analysis module comprises:
a historical retrieval records acquisition module, configured to acquire user's historical retrieval records in the mobile search system;
a retrieval type analysis module, configured to cluster analyzing the acquired user's historical retrieval records to obtain a retrieval type analysis model for the user;
a user's real-time scenario information acquisition module, configured to acquire real-time scenario information of the user's retrieval; and
a retrieval type determination module, configured to search the retrieval type analysis module for the user to find a retrieval type that matches the user's real-time scenario information, and make the retrieval type a part of the user's consumption characteristics information.

13. The apparatus of claim 11, wherein the consumption characteristics analysis module comprises: a user scenario information acquisition module, configured to acquire the real-time scenario information of the user's retrieval, and make the real-time scenario information a part of the user's consumption characteristics information.

14. The apparatus of claim 11, wherein the consumption characteristics analysis module comprises: a telecommunication service data acquisition module, configured to acquire the user's telecommunication service data, and making telecommunication service data a part of the user's consumption characteristics information.

15. The apparatus of claim 11, wherein the consumption characteristics analysis module comprises: mobile user statistics data acquisition module, configured to acquire the user's statistics data in a mobile internet system, and making the statistics data a part of the user's consumption characteristics information.

16. A machine readable medium, on which sets of instructions are stored, wherein the sets of instructions, when being executed, cause the machine to perform the steps of
acquiring a user's usage information in the mobile search system;
analyzing the acquired user's usage information to obtain the user's consumption characteristics information;
finding corresponding mobile media information that matches the user's consumption characteristics information; and
presenting the matched mobile media information.
